(19) United States
(12) Patent Application Publication
(10) Pub. No.: US 2025/0360894 A1
(43) Pub. Date: Nov. 27, 2025

(54) DEPLOYABLE MATERIAL CLEARING SYSTEM AND CORRESPONDING METHOD

(71) Applicant: Produits Hevea Inc., Richmond (CA)

(72) Inventors: Jean Deslauriers, Richmond (CA); Danny Blais, Richmond (CA); Guillaume St-Hilaire, Richmond (CA)

(21) Appl. No.: 19/215,616

(22) Filed: May 22, 2025

Related U.S. Application Data
(60) Provisional application No. 63/651,429, filed on May 24, 2024.

(51) Int. Cl. B60S 3/06

(52) U.S. Cl. CPC B60S 3/066

(57) ABSTRACT

The present disclosure concerns a deployable system for removing a material from a roof of a vehicle along its length. The deployable system includes a carrier-mounting support structure, a power unit, a deployable arm system and a material clearing apparatus. The deployable arm system is mounted to or formed integral with the mounting support structure and is operatively coupled to the power unit. Upon actuation of the power unit, a distal end portion of the deployable arm system is displaceable along the vehicle length to selectively extend the deployable arm system into an extended configuration or to collapse same into a compacted configuration. The material clearing apparatus is mounted to or formed integral with the deployable arm system to hover at least a portion of the material clearing apparatus over the roof to remove the material along the vehicle length upon actuation of the power unit.

### PRIOR APPLICATION

The present application claims priority from U.S. provisional patent application No. U.S. 63/651,429, filed on May 24, 2024, and entitled “DEPLOYABLE MATERIAL CLEARING SYSTEM AND CORRESPONDING METHOD,” the entire disclosure of which is incorporated herein by reference.

### TECHNICAL FIELD

The technical field relates to a clearing system and more particularly to a deployable material clearing system for removing a material, such as ice and/or snow, from a surface, such as a rooftop of a vehicle or a trailer, and to a corresponding method for removing the material from the surface.

### BACKGROUND ART

The accumulation of snow and/or ice on roofs and other surfaces of vehicles presents a serious hazard for drivers on the road. Blowing snow from the roofs of these vehicles can severely reduce visibility of the surroundings, thereby increasing the risks of accidents. This problem is of particular concern for the drivers and/or owners/operators of commercial vehicles such as tractor trailers, as the trailer portion of these vehicles tends to present a large surface area upon which ice and/or snow may build up. Moreover, some jurisdictions might impose a legal obligation to clear ice and/or snow from the vehicle roofs. In some cases, to comply with this legal requirement, drivers or employees climb atop the vehicle roofs and manually clear them of snow and ice. The task can be physically demanding, time-consuming, and can present a significant safety hazard to the driver/employee as the vehicle roof is often slippery.

In addition to safety concerns, logistical issues may arise when a plurality of vehicles—for instance a fleet of trucks, lorries, vans, buses and other commercial vehicles—must be cleared from snow and/or ice buildups during the winter months. In a generally found configuration, the vehicles are tightly parked parallel to one another to save limited parking space, thus leaving little room for other vehicles to circulate between the parked vehicles, especially on their lateral sides. Such constraints can impede a clearing operation of the roofs of the vehicles. Existing systems generally offer bulky and ill-suited means to operate in confined spaces as previously described.

Furthermore, the person skilled in the art would appreciate that ice/snow buildups can become difficult to remove in some circumstances. Depending on the atmospheric conditions, stratification and increased cohesion can occur, leading to compaction and adhesion to roof surfaces. In such conditions, a delicate balance should be reached to provide robust means to displace the ice and snow from the roofs without damaging the rooftops, which can be challenging if heavy equipment is used.

In view of the above, there is a need for a deployable system which would be able to overcome or at least minimize some of the above-discussed concerns.

### SUMMARY OF THE INVENTION

According to a general aspect of the disclosure, there is provided a deployable material clearing system for removing a material from a roof of a vehicle along a vehicle dimension thereof, the deployable material clearing system comprising: a support structure; a deployable arm system operatively couplable to a power unit and comprising: a proximal end portion mounted to or formed integral with the support structure; and a distal end portion; wherein upon actuation of the power unit, the distal end portion is displaceable along the vehicle dimension to selectively extend the deployable arm system into an extended configuration or to configure the deployable arm system into a compacted configuration; and a material clearing apparatus mounted to or formed integral with the distal end portion of the deployable arm system to hover at least a portion of the material clearing apparatus over the roof to remove the material along the vehicle dimension upon actuation of the power unit.

According to another general aspect, there is provided a deployable material clearing system for removing a material from a roof of a vehicle along a vehicle dimension thereof. The deployable material clearing system includes a carrier-mounting support structure, a power unit, a deployable articulated arm system operatively coupled to the power unit, and a material clearing apparatus. The carrier-mounting support structure includes a carrier-mounting portion and a platform portion. The deployable arm system includes a proximal end portion mounted to or formed integral with the platform portion and a distal end portion. Upon actuation of the power unit, the distal end portion is displaceable along the vehicle dimension to selectively extend the deployable arm system into an extended configuration or to configure the deployable arm system into a compacted configuration. The material clearing apparatus is mounted to or formed integral with the distal end portion of the deployable articulated arm system to hover at least a portion of the material clearing apparatus over the roof to remove the material along the vehicle dimension upon actuation of the power unit.

In an embodiment, the deployable articulated arm system is horizontally deployable.

In an embodiment, the platform portion extends perpendicularly to the carrier-mounting portion.

In an embodiment, the carrier-mounting portion of the carrier-mounting support structure defines at least one carrier-mounting slot sized and shaped to receive a portion of a carrier.

In an embodiment, the deployable arm system comprises at least one set of scissor arms, and wherein the proximal end portion and the distal end portion are located at opposite ends of the at least one set of scissor arms.

In an embodiment, the at least one set of scissor arms includes first and second sets of scissor arms. The second set of scissor arms is superposed and interconnected to the first set of scissor arms.

In an embodiment, the deployable arm system further comprises at least one arm actuator operatively coupled to the power unit and to the at least one set of scissor arms, to configure the deployable arm system into any one of the extended and compacted configurations.

In an embodiment, the at least one arm actuator includes at least one hydraulic cylinder.

In an embodiment, the deployable material clearing system further comprises at least one bumper extending distally from one of the carrier-mounting support structure and the proximal end portion of the deployable arm system, to abut on the vehicle.

In an embodiment, the at least one bumper includes an elongated support member connected to one of the carrier-mounting portion of the carrier-mounting support structure and the proximal end portion of the deployable arm system, the elongated support member comprising a distal end at least partially formed of a resilient material.

In an embodiment, the deployable system further includes further includes a wheel assembly mounted to or at least partially formed integral with a lower portion of the deployable arm system, the wheel assembly including at least one wheel axle and a plurality of wheels, each wheel being coupled to a corresponding wheel axle, the wheels being oriented in alignment with a deployment direction of the deployable arm system.

In an embodiment, each of the at least one wheel axle is mounted to or formed integral with a respective axle pin assembly of the deployable arm system.

In an embodiment, the material clearing apparatus is configured to remove the material from the roof of the vehicle upon extension of the deployable arm system.

In an embodiment, the material clearing apparatus comprises a clearing body and a plow, the clearing body being coupled to the distal end portion of the deployable arm system and the plow extending downwardly with respect to the clearing body to scrape the roof and enable the removal of the material off the roof.

In an embodiment, the plow has a V-shape oriented to evacuate the material over lateral edges of the roof as the deployable arm system is being extended into the extended configuration.

In an embodiment, the material clearing apparatus comprises a driver system and a rotating material remover operatively coupled to the driver system. The driver system is operatively coupled to the power unit to selectively actuate the rotating material remover.

In an embodiment, the plow is a funneling plow adapted to direct material to a mouth of the rotating material remover.

In an embodiment, the material includes ice and/or snow.

According to another general aspect, there is provided a deployable system for hovering an apparatus over a roof of a vehicle along a vehicle dimension thereof, the deployable system comprising: a support structure; a deployable arm system operatively couplable to a power unit and comprising: a proximal end portion mounted to or formed integral with the support structure; and a distal end portion; wherein upon actuation of the power unit, the distal end portion is displaceable along the vehicle dimension to selectively extend the deployable arm system into an extended configuration or to configure the deployable arm system into a compacted configuration; and an apparatus-mounting frame mounted to or formed integral with the distal end portion of the deployable arm system, adapted to be coupled with the apparatus and to hover the apparatus over the roof upon actuation of the power unit.

According to another general aspect, there is provided a deployable system for hovering an apparatus over a roof of a vehicle along a vehicle dimension thereof. The deployable material clearing system includes a carrier-mounting support structure, a power unit, a deployable articulated arm system operatively coupled to the power unit, and an apparatus-mounting frame. The carrier-mounting support structure includes a carrier-mounting portion and a platform portion. The deployable arm system includes a proximal end portion mounted to or formed integral with the platform portion and a distal end portion. Upon actuation of the power unit, the distal end portion is displaceable along the vehicle dimension to selectively extend the deployable arm system into an extended configuration or to configure the deployable arm system into a compacted configuration. The apparatus-mounting frame is mounted to or formed integral with the distal end portion of the deployable arm system, adapted to be coupled with the apparatus and to hover the apparatus over the roof upon actuation of the power unit.

According to another general aspect, there is provided a method for removing a material from a surface along a dimension thereof, the method comprising: providing a deployable material clearing system having a support structure, a deployable arm system, and a material clearing apparatus; mounting the support structure to a structure-receiving member, the structure-receiving member being at a desired installation-height from a ground such that at least a portion of the material clearing apparatus hovers over the surface; aligning a deployment direction of the deployable arm system with the dimension of the surface; and deploying the deployable arm system along the dimension of the surface to operate the material clearing apparatus.

According to another general aspect, there is provided a method for removing a material from a surface along a dimension thereof, the method comprising: providing a deployable material clearing system having a carrier-mounting support structure, a deployable arm system, and a material clearing apparatus; mounting the carrier-mounting support structure to a structure-receiving member, the structure-receiving member being at a desired installation-height from a ground such that at least a portion of the material clearing apparatus hovers over the surface; aligning a deployment direction of the deployable arm system with the dimension of the surface; and deploying the deployable arm system along the dimension of the surface to operate the material clearing apparatus.

According to another general aspect, there is provided a method for removing a material from a surface along a length thereof. The method includes: providing a deployable material clearing system having a carrier-mounting support structure, a deployable arm system, and a material clearing apparatus; mounting the carrier-mounting support structure to a structure-receiving member of a carrier, a height of the structure-receiving member being adjustable; moving the carrier to align a deployment direction of the deployable arm system with a longitudinal axis of the surface; adjusting the height of the structure-receiving member to a desired installation-height from a ground such that at least a portion of the material clearing apparatus hovers over the surface; and deploying the deployable arm system along the length of the surface to operate the material clearing apparatus.

In one embodiment, the deployable material clearing system further comprises a bumper. The method further comprises abutting the bumper in a vicinity of the surface.

### BRIEF DESCRIPTION OF DRAWINGS

FIG. 1 is a rear top perspective view of a deployable material clearing system having a carrier-mounting support structure, a deployable articulated arm system, and an apparatus-mounting frame, showing the deployable articulated arm system in a partially extended configuration, in accordance with an embodiment;

FIG. 2 is a top plan view of the deployable material clearing system shown in FIG. 1, wherein the deployable articulated arm system is further deployed in the extended configuration relative to the deployable articulated arm system shown in FIG. 1;

FIG. 3 is a rear top perspective view of the carrier-mounting support structure shown in FIG. 1;

FIGS. 4A and 4B show the deployable material clearing system shown in FIG. 1, further including a material clearing apparatus in accordance with a first embodiment, the material clearing apparatus comprising a plow having an inverted V-shape, wherein the deployable articulated arm system is in a compacted configuration; FIG. 4A is a top plan view of the deployable material clearing system; FIG. 4B is a left-side elevation view of the deployable material clearing system;

FIGS. 5A and 5B show the deployable material clearing system shown in FIG. 1, further including a material clearing apparatus in accordance with another embodiment, the material clearing apparatus comprising a plow having an inverted V-shape, a driver system and a rotating material remover; FIG. 5A is a top plan view of the deployable material clearing system; FIG. 5B is a left-side elevation view of the deployable material clearing system;

FIGS. 6A, 6B and 6C show the deployable material clearing system shown in FIG. 1, further including a material clearing apparatus in accordance with another embodiment, the material clearing apparatus comprising a funneling plow, a material removal assembly, and a deflector; FIGS. 6A, 6B and 6C are respectively a top plan view, a left-side elevation view, and a rear elevation view of the deployable material clearing system;

FIGS. 7A, 7B and 7C show the deployable material clearing system shown in FIG. 1, further including a material clearing apparatus in accordance with another embodiment, the material clearing apparatus comprising a rotating material remover, a funnel, an evacuation system and a driver system; FIGS. 7A, 7B and 7C are respectively a top plan view, a left-side elevation view, and a rear elevation view of the deployable material clearing system;

FIG. 8 is a left-side elevation view of a portion the deployable material clearing system excluding the deployable arm system and the material clearing apparatus, in accordance with another embodiment, and wherein the deployable material clearing system is mounted to a stand fixed to chassis of a carrier;

FIG. 9 is a front perspective view of another carrier mounted with a deployable material clearing system including a deployable telescopic arm system, in accordance with another embodiment;

FIGS. 10A, 10B and 10C show a carrier-receiving plate of the carrier-mounting support structure, in accordance with another embodiment, wherein the carrier-receiving plate includes a quick-attach system; FIGS. 10A, 10B and 10C are respectively a rear perspective view, a rear elevation view, and a right side elevation view of the carrier-receiving plate; and

FIG. 11 shows a side perspective view of a deployable material clearing assembly comprising the deployable material clearing system of FIG. 1 mounted to a support structure.

### DETAILED DESCRIPTION

In the following description, although the embodiments of a deployable material clearing system and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the deployable material clearing system, including the vehicle-mounting support structure, the deployable arm system, and the material clearing apparatus, as will be briefly explained herein and as can be inferred therefrom by a person skilled in the art. Moreover, it will be appreciated that positional descriptions such as “above”, “below”, “left”, “right” and the like should, unless otherwise indicated, be taken in the context of the figures and should not be considered limiting.

As will be explained below in relation to various embodiments, the present disclosure describes systems and devices for facilitating a removal of a material from a surface, such as snow and/or ice accumulated on a roof of a vehicle along a length thereof.

### Deployable Material Clearing System

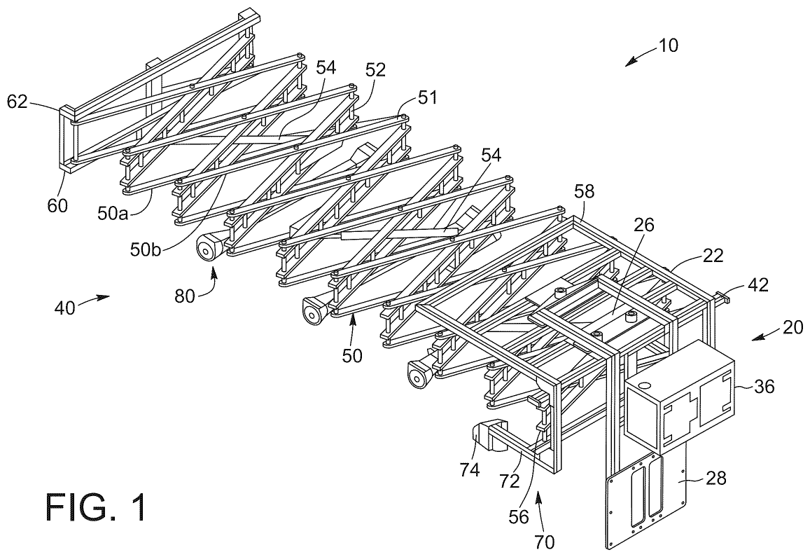

With reference to FIGS. 1-7C, a deployable material clearing system 10 (hereinafter the “deployable system” 10) is provided. The deployable system 10 is adapted to enable and/or facilitate a removal of a foreign material accumulated on a substantially planar surface along a dimension thereof. The substantially planar surface can for instance be a rooftop of a vehicle defining a vehicle length thereof. In the following description, it will be referred to a length of the planar surface, but any other dimensions of the planar surface could be considered.

The term “material” as used herein can take different forms depending on environmental factors. For instance, a mixture of snow and ice is described herein, but alternatively or in addition, the material could include dust, other undesirable foreign particles or objects, or any combination thereof. In view of providing an exemplary embodiment, the deployable system 10 is described in the context of snow and/or ice removal, but this example of the “material” is not to be considered as limiting.

It should be noted that the term “clearing”, or any similar expression as used herein, generally refers to the act of removing the material from the surface. For example, the term “clearing” is to be understood as the complete or partial removal of the material from the surface, for instance, by pushing aside, scraping, vacuuming, brushing, blowing and spraying, depending on the embodiment of the deployable system 10 and more particularly the material clearing apparatus 90, 190, 290, 390 that comes into contact with, or in proximity of, the planar surface to be cleared.

As mentioned, it should be noted that the terms “surface” or “roof” as used interchangeably herein to refer to the subject of the material removal can be understood as any substantially planar surface (for instance substantially horizontal), which can include a slightly concave roof top surface of a stationary vehicle. As such, the roof of a vehicle is provided as an example and should not be considered as limiting. Other surfaces that can be cleared by the deployable system 10 can include, for example, a roof of a trailer, a roof of a structure, a horizontal platform, or a topside of container. In other words, the deployable system 10 can interact with several surface setups that may require clearing of a material. Furthermore, the term “vehicle length” refers to a length of a rooftop of a vehicle that can be cleared by the deployable system 10 and does not necessarily include a full length of the vehicle rooftop.

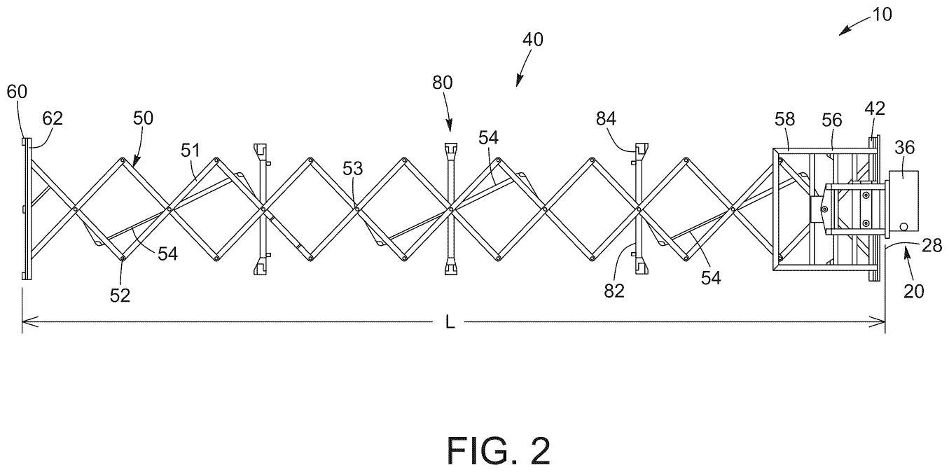

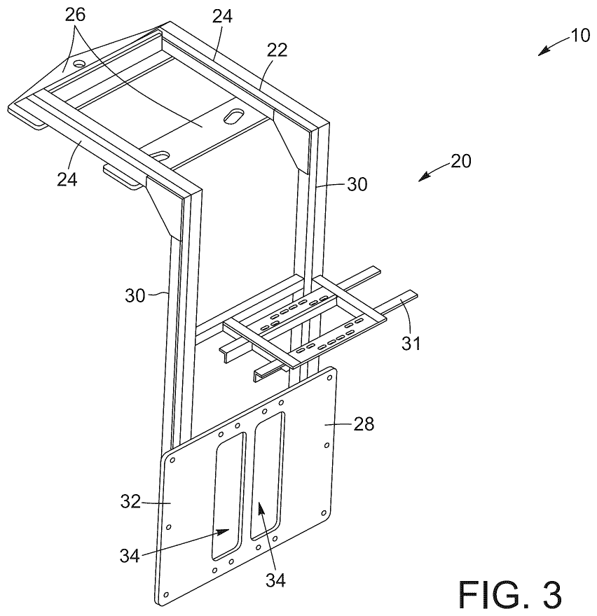

With reference to FIGS. 1-2, the deployable system 10 includes a carrier-mounting support structure 20 (hereinafter, the “support structure” 20) and a deployable articulated arm system 40 (hereinafter, the “articulated arm system” 40) mounted to—or formed integral with a portion of—the support structure 20. According to embodiments described herein, the deployable system 10 can further include a material clearing apparatus 90, 190, 290, 390 mounted to or formed integral with the articulated arm system 40. In the embodiments shown, the components of the deployable system 10 are interconnected into a single assembly, but could be disassembled into their constituents, as shown in FIG. 3 in regard to the support structure 20.

### Support Structure

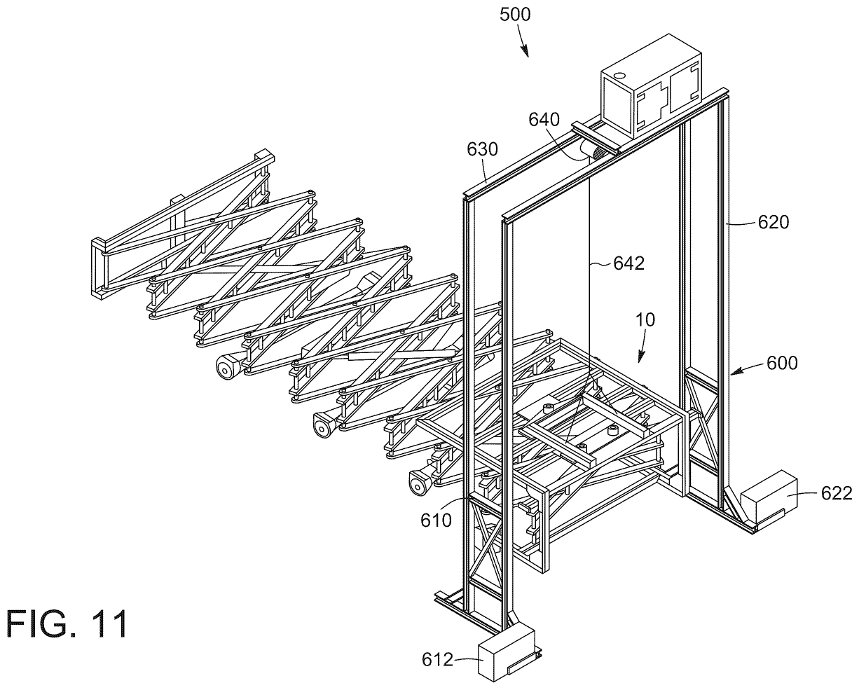

With reference to FIGS. 1-7C, the support structure 20 of the deployable system 10 is adapted to be mounted onto a carrier 7 or a portion thereof. As detailed below with reference to FIG. 11, the support structure 20 could also be configured to be mounted to an archway structure or to any other type of system-suspending structure.

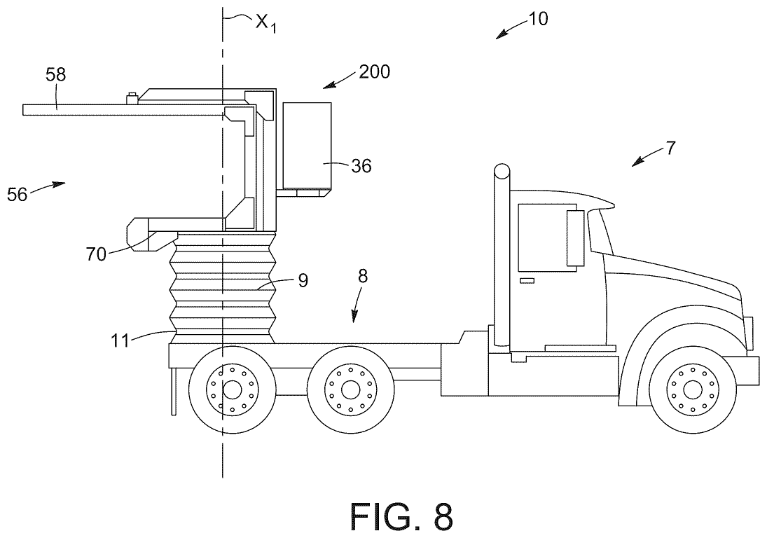

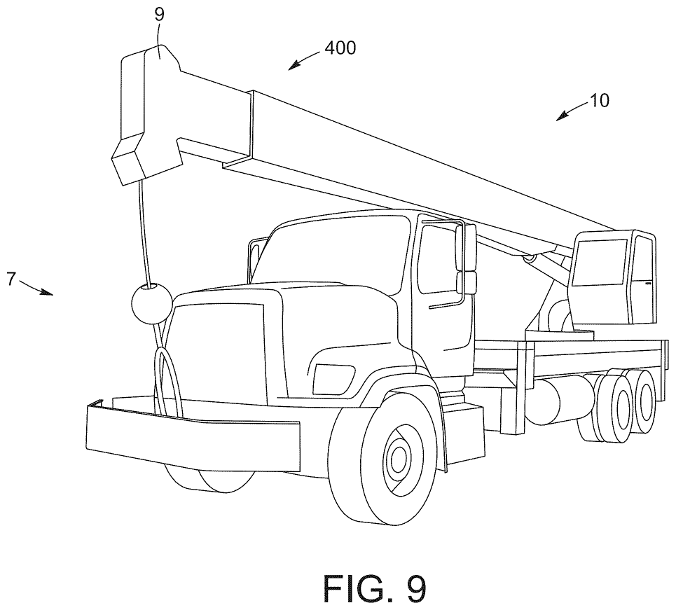

With reference to FIGS. 1-7C, the support structure 20 will be referred to as a carrier-mounting support structure 20, since the support structure 20 is configured to be mounted, in these shown embodiments, to a carrier. The support structure 20 is adapted to support other components of the deployable system 10, such as the articulated arm system 40, as explained in more details below. It is appreciated that the deployable system 10 can be considered portable (e.g., FIG. 8) since the carrier 7 or a portion thereof can displace and position the deployable system 10 in proximity of a surface to be cleared, as explained in more details below in relation to a clearing method. It will be noted that the term “portable”, as used herein, is to be understood as meaning having the characteristics for being more easily carried or displaced compared to an industry standard in the art of ice and/or snow removal equipment, at least in part because of its lighter and smaller build. The “carrier” could be any type of carrier-type vehicle such as, and without being limitative, a boom truck (FIG. 9), a forklift, a wheel loader, and a truck. The semi-trucks illustrated in FIGS. 8 and 9 are not limitative of the implementation of the deployable system 10.

As better shown in FIG. 3, the support structure 20 can include at least a carrier-mounting portion 28 to be mounted to the carrier 7 or a portion thereof, and a platform portion 22 to support the articulated arm system 40. In one embodiment, the support structure 20 can also include the power unit 36 (i.e., a power assembly).

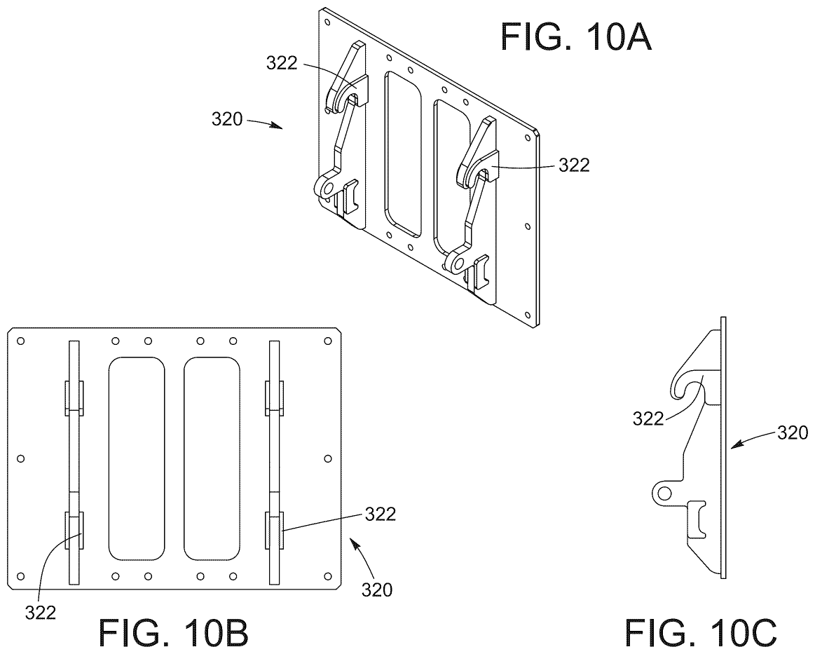

Still referring to the embodiment shown in FIG. 3, the carrier-mounting portion 28 includes two posts 30 arranged parallel one another and a carrier-receiving plate 32 (or carrier-securing member) fixed to both posts 30. The carrier-receiving plate 32 serves to mount the support structure 20 onto the carrier or a portion thereof (i.e., a structure-receiving member 9 of the carrier 7). As such, in the embodiment shown, the carrier-receiving plate 32 defines at least one carrier-mounting slot 34 (two, in the embodiment shown). Without being limitative, the location, number, size and shape of the carrier-mounting slot 34 can vary from the embodiment shown to adaptively engage or mount a corresponding carrier or a portion thereof. In the embodiment shown, the carrier-receiving plate 32 defines a pair of parallel vertical carrier-mounting slots 34 sized and shaped to receive and engage a pair of forks of a forklift carriage. According to an alternative embodiment of the carrier-receiving plate 320 shown in FIGS. 10A-10C, the carrier-receiving plate 320 shown is similar to the carrier-receiving plate 32 embodied in FIG. 1, except that a rear surface of the carrier-receiving plate 320 further includes “quick-attach system” type protrusions 322 to alternatively mount to a corresponding structure-receiving member of a carrier 7 of the “quick-attach system” type. According to yet another alternative embodiment (not shown), the carrier-receiving plate 32 can be permanently or semi-permanently secured to the structure-receiving member of the carrier, for instance by bolting or welding the carrier-receiving plate 32 to the structure-receiving member.

A vertical length of the posts 30, and other components of the deployable system 10, can be adjusted so that a desired height from a ground of the articulated arm system 40 mounted or formed integral thereto can be achieved. For instance, in one embodiment, the deployable system 10 is sized such that the articulated arm system 40 is deployable starting at a height of 13 feet and 6 inches (or about 4.1 meters).

According to the embodiment shown in FIG. 3, the support structure 20 also includes a power unit platform 31 to support and hold the power unit 36 (power unit not shown in FIG. 3). In the embodiment, the power unit platform 31 extends in a proximal direction (i.e., in a direction opposed to the deployment direction of the articulated arm system when assembled with the support structure) and perpendicularly to the carrier-mounting portion 28 and is located above the carrier-receiving plate 32 of the carrier-mounting portion 28. As shown in FIGS. 1-2, 4A-8, the power unit 36 is encased in a housing. The housing may hold other components, such as a controller, a diesel motor, a diesel tank fluidly connected to the diesel motor, a hydraulic pump and electric generator operatively coupled to the diesel motor. Alternatively or additionally, the power unit 36 may include an electric battery operatively connected to other working components such as the hydraulic pump to replace the diesel motor and implement an electric version of the deployable system 10. According to yet another alternative embodiment in which the diesel motor is not included in the power unit 36, the power unit 36 can be operatively connected to a power takeoff (PTO) of a carrier 7 fitted with a PTO to provide power directly to the hydraulic pump, for instance. A hybrid version of the deployable system 10 according to one or more of the embodiments of the power unit 36 previously described is also envisioned. It could also be conceived a deployable material clearing system which would not include a power unit, but wherein the deployable arm system would be operatively couplable to a power unit.

According to an embodiment, the support structure 20 includes a ballast (not shown) to counterweight a lever force exerted by the articulated arm system 40 as it is being deployed in the opposite deployment direction. The ballast can be added into the housing or mounted or formed integral to the carrier-mounting portion 28 of the support structure 20.

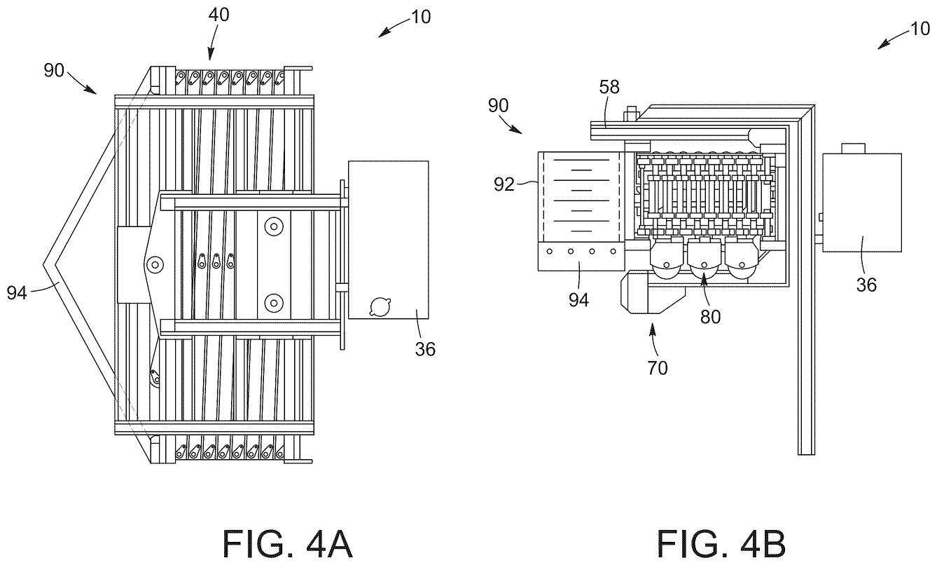

According to the embodiment of the support structure 20 shown in FIG. 3, the platform portion 22 extends in the deployment direction and substantially perpendicular to the posts 30 of the carrier-mounting portion 28. As shown in the embodiment, the platform portion 22 has two cantilevered supports 24 respectively fixed to the two posts 30 of the carrier-mounting portion 28 about a top extremity thereof. Moreover, the platform portion 22 further includes arm-receiving plates 26 fixed to the cantilevered supports 24. In the embodiment show, the platform portion 22 has two arm-receiving plates 26, with one arm-receiving plate 26 transversely fixed at a distal extremity of the cantilevered supports 24. The arm-receiving plates 26 can include fasteners or fastening means (shown in FIGS. 4A-7C) for securing the articulated arm system 40 to the support structure 20. Other means could be conceived, such as welds, to secure the articulated arm system 40 to the support structure 20. According to an alternative embodiment (not shown), the articulated arm system 40 is formed integral with a portion of the support structure 20 (for instance with the platform portion thereof).

According to an alternative embodiment (not shown), the support structure 20 can be adapted to mount and secure the articulated arm system 40 above the platform portion 22 (i.e., in an upward direction) instead of beneath the platform portion 22 as shown in FIGS. 1-8 (i.e., in a downward direction).

It is appreciated that in the structural arrangements of the support structure 20 shown in FIGS. 1-8, the platform portion 22 is located above the carrier-mounting portion 28 when the support structure 20 is upright (FIG. 3). Particularly, a vertical distance between the carrier-receiving plate 32 of the carrier-mounting portion 28 and the arm-mounting plates 26 of the platform portion 22 allows for a vertical clearance of the articulated arm system 40, and by extension the clearing apparatus 90, 190, 290, 390 when a clearing apparatus is provided. It is appreciated that a vertical length of the carrier-mounting portion 28 of the support structure 20 can be adjusted compared to the embodiment shown to correspondingly reach a higher surface that should be cleared from a material. It is appreciated that some carriers may not be equipped to independently and/or sufficiently raise the deployable system 10 to reach a high surface to be cleared.

### Deployable Arm System

With reference to the embodiment shown in FIGS. 1-7C, and as better shown in FIG. 2, the arm system 40 is operatively coupled to the power unit 36 and includes, for instance and without being limitative, at least one set of scissor arms 50 to enable the reversible deployment (i.e., a deployment or collapse of the articulated arm system 40) from a compacted configuration (FIGS. 4A-7C) into an extended configuration (FIGS. 1-2). In an embodiment of the deployable system 10 in a fully extended configuration, an arm length L (see FIG. 2) defined between the carrier-mounting portion 28 of the support structure 20 and a distal end portion 60 of the articulated arm system 40 is approximately 66 feet (or about 20 meters). The arm length L of the deployable system 10 in a fully compacted configuration (FIGS. 4A-7C) is approximately 6 feet (or about 1.82 meters).

In the embodiment shown in FIGS. 1-7C, two superposed sets of scissor arms are provided 50a, 50b (i.e., a “two-level articulated arm system”). The articulated arm system 40 has a proximal end portion 56 mounted to or formed integral with the support structure 20, as described above, and a distal end portion 60, displaceable with respect to the proximal end portion 56, for varying the arm length L. The proximal end portion 56 and the distal end portion 60 are located at opposite ends of the at least one set of scissor arms 50. In the embodiment shown, the articulated arm system 40 also includes an apparatus-mounting frame 62 mounted to or formed integral with the distal end portion 60, as explained in more details below.

It should be noted that the terms “proximal” and “distal”, as they are used herein, refer to a position of a component of the deployable system 10 when mounted to a carrier 7 with the carrier-mounting portion 28 of the support structure 20 as reference point, and with a proximal position being closer to the carrier-mounting portion 28 than a distal position.

As will be explained in more details below with reference to FIGS. 4A-7C, the material clearing apparatus 90, 190, 290, 390 can be mounted to or formed integral with the distal end portion 60 of the articulated arm system 40 to hover at least a portion of the material clearing apparatus 90, 190, 290, 390 over the roof to remove the material along the vehicle length upon actuation of the power unit 36, and thus upon deployment of the arm system 40.

According to the embodiment shown in FIGS. 1-7C, the proximal end portion 56 of the articulated arm system 40 includes an overhanging arm base 58 that is mountable to or formed integral with the support structure 20. As specifically represented in the non-limiting embodiment shown in FIG. 2, when assembled, the overhanging arm base 58 is mounted and can be fastened to an underside of the arm-receiving plates 26 of the support structure 20.

The set of scissor arms 50 of the articulated arm system 40 includes a base 42, cross brace supports 51 that are pivotally interconnected with hinge pins 52 and axle pin assemblies 53. The articulated arm system 40 also includes a cam follower at an extremity of the most proximal and distal cross brace supports 51 to allow a tip thereof to slide respectively along a railing of the base 42 and a railing of the apparatus-mounting frame 62 as the articulated arm system 40 transitions between the compacted and the extended configurations. In the non-limiting embodiment shown, the sets of scissor arms 50a, 50b each have eighteen cross brace supports 51.

For the purpose of this disclosure, the articulated arm system 40 is shown as having two sets of scissor arms 50a, 50b. However, a greater or smaller number of scissor arms sets 50 and/or sets of varying shape and structure can be implemented. According to an alternative embodiment (not shown), the articulated arm support 40 includes one set of scissor arms 50 (i.e., a “one-level articulated arm system”).

The exemplary embodiments described herein describe a deployable system 10 adapted for horizontal deployment over a horizontal surface to be cleared. It will be appreciated that, depending on a mode of use, the deployable system 10 may be oriented as desired for a deployment in a vertical or tilted orientation, for instance, provided that the carrier 7 enables a non-horizontal orientation.

In an embodiment of the articulated arm system 40 including two sets of scissor arm 50a, 50b, as shown in FIGS. 1-7C, a first set of scissor arms 50a is provided as previously described, and a second set of scissor arms 50b is superimposed to the first set of scissor arms 50a such that the first and second sets of scissor arms 50a, 50b share the same hinge pins 52 and axle pin assemblies 53 at corresponding locations. In other words, the second set of scissor arm 50b is vertically spaced apart in an upward direction from the first set of scissor arms 50a. The second set of scissor arms 50b is mounted or formed integral with the platform portion 22 of the support structure 20, as previously described.

It is appreciated that an embodiment having a plurality of superposed scissor arms 50 provides additional longitudinal rigidity to the articulated arm system 40. Even though the deployable system 10 can be provided with wheel assemblies 80 to engage the surface to be cleared as explained in more details below, thus supporting some of the weight of the system 10, it may be preferable in some circumstances to provide an embodiment of the deployable system 10 in which the articulated arm system 40 is “freestanding”, such that wheel assemblies 80 are not critical to allow the articulated arm system 40 to reach an extended configuration before a structural failure.

According to one embodiment, the cross brace supports 51 of the scissor arms 50 are tubular. In the embodiment, wires and/or hydraulic tubing pass within the hollow tubular cross brace supports 51 to operatively connect different components of the deployable system 10, for example the power unit 36 with actuators and/or the material-clearing apparatus 90, 190, 290, 390. This concealed arrangement of the wires and/or tubing in relation to the sets of scissor arms 50 avoids or limits an undesirable interference between the wires and/or tubing and other moving parts of the deployable system 10 and/or the surface to be cleared.

As previously mentioned, the power unit 36 can include a controller. The controller is operatively interconnected to selectively actuate other components of the power unit 36. In one embodiment, the controller is connectable through a communication network, to a processing entity (e.g., located in or about the carrier 7) over a communication link, which may be implemented over a cellular network, a WiFi network or other wireless LAN, a WiMAX network or other wireless WAN, etc. such that an operator may control the deployable system 10 over a certain distance.

According to one embodiment, the articulated arm system 40 further includes at least one arm actuator 54 operatively coupled to the power unit 36 and to the at least one set of scissor arms 50 (to cross brace supports 51 thereof, for instance). In the embodiment shown in FIGS. 1-7C, and as better shown in FIG. 2, three arm actuators 54, each including a hydraulic cylinder, are provided. As shown, a first (proximal) arm actuator 54 is connected to the first and third axle pin assemblies 53, a second arm actuator 54 is connected to a fourth and a sixth axle pin assemblies 53, and a third arm actuator 54 is connected to a seventh and a ninth axle pin assemblies 53. According to an alternative embodiment (not shown), the arm actuator 54 is connected to an axle pin assembly 53 at one end, and to a section of a cross brace support 51 at the other end. The person of ordinary skill would understand that other suitable arrangements for the arm actuators 54 and scissor arms 50 exist in the art and can be implemented to the present disclosure with adjustments.

The power unit 36 provides energy to each arm actuator 54 to enable the selective extension or collapse of the articulated arm system 40 into the extended or compacted configurations. In one embodiment, the actuators 54 include at least one hydraulic cylinder. As mentioned, the power unit 36 can include a hydraulic pump to provide pressurized fluid to the hydraulic cylinders. In an alternative embodiment, the power unit 36 belongs to the articulated arm system 40, for instance. In other words, the location of the power unit 36 within the deployable system 10 can be rearranged without departing from the scope of the present disclosure.

In the embodiment shown in FIG. 1, the apparatus-mounting frame 62 is mounted to or formed integral with the distal end portion 60 of the articulated arm system 40. The apparatus-mounting frame 62 can be used to mount or attach a material-clearing apparatus, of which several exemplary embodiments are illustrated in FIGS. 4A-7C.

According to alternative embodiments, a material-clearing apparatus is not the only device that may be provided for the deployable system 10. For instance, and without being limitative, a mining equipment or an apparatus for dispensing fluid (e.g., cleaning fluid, deicing fluid, fire suppression fluid) could be mounted to the mounting frame 62 to position the apparatus in question in an area otherwise beyond reach.

According to an alternative embodiment of the deployable arm system shown in FIG. 9, the deployable arm system 400 is not “articulated” such as the embodiment of the deployable arm system 40 illustrated in FIGS. 1-7C. Rather, the deployable arm system of FIG. 9 is a deployable telescopic arm system 400 that is extendable in stages, the number of which depends on the telescopic arm mechanism. It is understood that the telescopic arm system 400 can be mounted to or formed integral with an apparatus-mounting frame 62 as previously described. The telescopic arm system 400 illustrated in FIG. 9 is for illustrative purposes only and other types, sizes and shapes of telescopic arm systems known in the art can be implemented therewith.

### Bumper

With reference to the embodiment shown in FIGS. 1-8, the deployable system 10 also includes a bumper 70 to absorb at least some of the force that may result from the deployable system 10 approaching the surface for a material clearing operation. According to one mode of use of the deployable material clearing system 10 shown in FIGS. 1-8, the support structure 20 is positioned proximate to a periphery or side of the surface to be cleared so that the articulated arm system 40 may be extended to operate the material-clearing apparatus 90, 190, 290, 390. As such, the bumper 70 may dampen the impact resulting from a contact between the periphery or side of the surface to be cleared (e.g., a side of a vehicle having a rooftop surface) and the deployable system 10 to avoid or limit shock damage to either.

According to the embodiment shown in FIGS. 1-8, the bumper 70 extends distally from the proximal end portion 56 of the articulated arm system 40. More specifically, in the embodiment, the bumper 70 includes at least one elongated support member 72, e.g., an elongated support rod 72, connected to the overhanging arm base 58 of the proximal end portion 56. The elongated support rod 72 has a distal end 74 at least partially formed of a resilient material, sized, shaped and oriented to absorb an impact force in the longitudinal direction of the elongated support rod 72. For instance, a length of the elongated support rod 72 could be modified, in order to comply with vehicles of different dimensions. For instance, the elongated support rod 72 comprises a telescopic member configurable into retracted and deployed configurations. According to alternative non-limiting embodiments (not shown), the bumper 70 may include one of a spring, a spring bar, a padding, a shield and any combination thereof.

According to another embodiment (not shown), alternatively or in addition to the bumper 70, the deployable system 10 (not shown) includes a plurality of distance sensors (optical sensors, such as cameras, lasers, and the like) capable of sensing a distance between a lower portion of the overhanging arm base 58, for instance, and the side of the vehicle to be cleared. It is appreciated that the distance sensor configuration can vary from the embodiment described herein. The distance sensor could also be operatively coupled to the elongated support rod via a rod actuator in order to adapt the length of the elongated support rod based on the sensed distance. The distance sensor can be operatively connected to an alarm system configured to emit a sound and/or visual signal when the detected distance falls below a predetermined minimal limit, indicating that a collision with the side of the vehicle is imminent, or can be operatively coupled to the power unit in order to stop a displacement of the arm system when the detected distance falls below the predetermined minimal limit.

### Wheel Assembly

With reference to the embodiments shown in FIGS. 1-7C, the deployable system 10 is provided with a wheel assembly 80 (or arm deployment-assisting system 80) mounted to or at least partially formed integral with a lower portion of the articulated arm system 40. As mentioned above, the articulated arm system 40 is deployable over the surface to be cleared so as to hover the material clearing apparatus 90, 190, 290, 390 proximate to the surface to enable the removal of snow and/or ice. The wheel assembly 80 can engage the surface to guide and support the deployment of the articulated arm system 40 on said surface while ensuring that the material clearing apparatus remains 90, 190, 290, 390 at a predetermined controlled distance from said surface.

With reference to the embodiments of FIGS. 1-7C, the wheel assembly 80 includes at least one wheel axle 82 and a plurality of wheels 84. Each wheel axle 82 is coupled with a pair of wheels 84 at opposing ends thereof. In the embodiment shown, each wheel axle 82 is coupled to or formed integral with a respective axle pin assembly 53 protruding below the lower portion of the articulated arm system 40. Each wheel 84 is oriented in alignment with a deployment direction of the deployable articulated arm system 40 such that a rotation axis of each wheel 84 is perpendicular to the deployment direction. In the embodiment shown, to enable such alignment of the wheels 84, each wheel axle 82 is oriented perpendicularly to the longitudinal deployment direction of the articulated arm system 40.

According to an embodiment (not shown), the wheel assembly 80 includes a motor to drive the wheels 84 in both directions on a deployment axis. The motor can be implemented independently or in combination with the arm actuators 54 of the articulated arm system 40 previously described, in order to ease and contribute to any one of the extended and compacted configurations of the arm system.

### Material Clearing Apparatus

In the embodiments shown in FIGS. 1-8, the material clearing apparatus 90, 190, 290, 390 is configured to remove material from the roof of the vehicle upon extension of the deployable articulated arm system 40. As a result, at least a portion of the material clearing apparatus 90, 190, 290, 390 hovers over the roof to remove the material along the vehicle length upon actuation of the power unit 36. As previously described, the material clearing apparatus 90, 190, 290, 390 can be mounted to or formed integral with the distal end portion 60 of the articulated arm system 40 or to the apparatus-mounting frame 62.

With reference to FIGS. 4A-7C, various embodiments of the material clearing apparatus 90, 190, 290, 390 are shown. The embodiments shown are adapted to clear ice and/or snow from a rooftop of a vehicle along a length thereof.

It should be noted that the embodiments of the material clearing apparatus 90, 190, 290, 390 are not to be limited to the embodiments described herein. For instance, the material clearing apparatus could be embodied partially or entirely by the apparatus for clearing ice from a vehicle roof disclosed in PCT Application No. PCT/CA2023/050212.

Referring to the embodiment shown in FIGS. 4A and 4B, the material clearing apparatus 90 is adapted to remove material from the roof of the vehicle upon extension of the articulated arm system 40. In the embodiment shown, the material clearing apparatus 90 has a clearing body 92 and a plow 94. The clearing body 92 is coupled to the distal end portion 60 of the articulated arm system 40 or the apparatus-mounting frame 62. In one embodiment (not shown), the clearing body 92 is attached to the apparatus-mounting frame 62 directly or indirectly via chains. The plow 94 extends downwardly with respect to the clearing body 92 to scrape the roof and thus enables the removal of material off the rooftop. In the embodiment shown, the plow has a V-shape (hereinafter, the “V-shape plow” 94) oriented to evacuate the material over lateral edges of the rooftop as the articulated arm system 40 is extended into the extended configuration. In other words, the plow 94 has a V-shape when observed from above (FIG. 4A) that defines a triangle profile formed with a base extending along the width of the apparatus-support frame 62 of the articulated arm system 40 and two moldboards that form the other two sides of the triangle. The moldboards are sized and oriented such that the V-shape plow 94 forms an isosceles triangle having a distal vertex substantially aligned with the longitudinal axis of the articulated arm system 40, again when observed from a top plan view. The moldboards can be adapted in accordance with the art of snow and/or ice plowing and to limit wearing of the roof surface of the vehicle. In order to evacuate the material over lateral edges of the roof upon displacement of the material clearing apparatus in the deployment direction, the distal vertex of the plow extends away from the base of the triangle considered along the deployment direction.

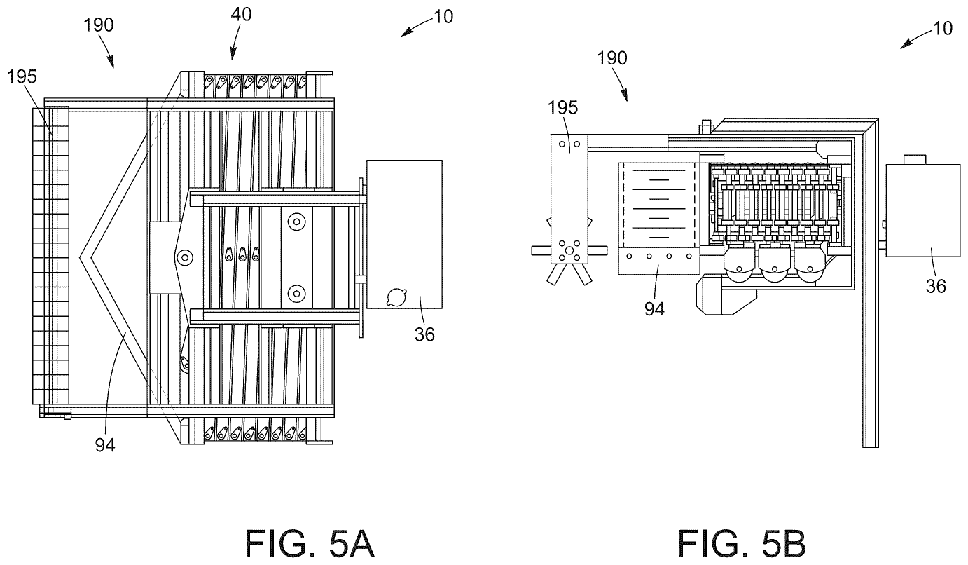

Turning to FIGS. 5A to 5B, there is shown an alternative embodiment of the material clearing apparatus 190 wherein the features are numbered with reference numerals in the 100 series which correspond to the reference numerals of the previous embodiment. The material clearing apparatus 190 shown in FIGS. 5A and 5B is similar to the material clearing apparatus shown in FIGS. 4A and 4B, except that the material clearing apparatus also includes a driver system and a rotating material remover 195 operatively coupled to the driver system. In one embodiment, the driver system 195 is operatively coupled to the power unit 36 to selectively actuate the rotating material remover. The rotating material remover 195 and the driver system may be substituted in part or in totality by the “ice-tapping assembly” described in PCT Application No. PCT/CA2023/050212, the entire disclosure of which is incorporated herein by reference.

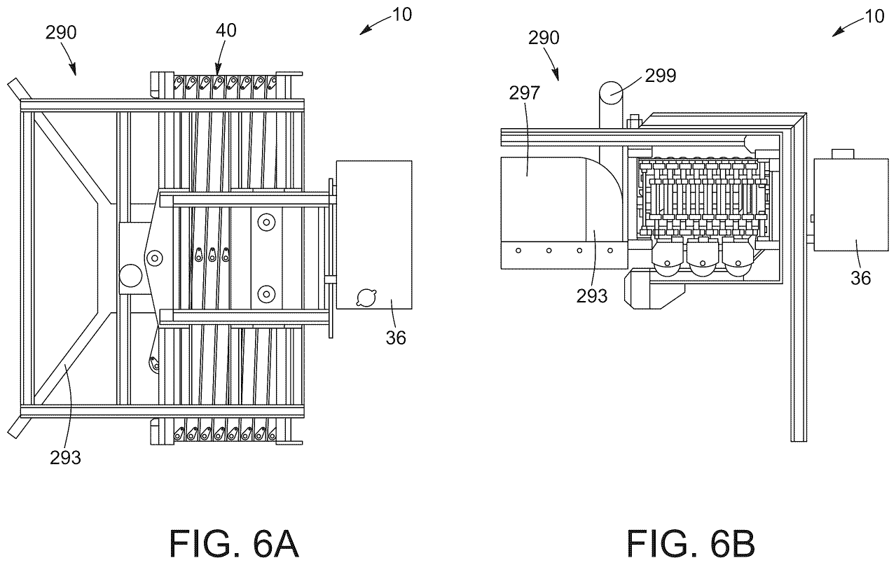

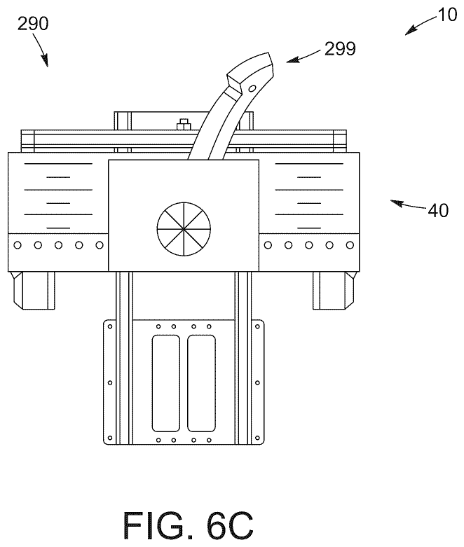

Turning to FIGS. 6A to 6C, there is shown another alternative embodiment of the material clearing apparatus 290 in which the features are numbered with reference numerals in the 200 series which correspond to the reference numerals of the previous embodiments. The material clearing apparatus 290 shown in FIGS. 6A-6C is exempt from the V-shape plow shown in FIGS. 5A-5B and instead features a “funneling plow” 293 and a material removal assembly having a mouth and an impeller. According to the embodiment, the funneling plow 293 has moldboards that extend away from lateral extremities of the mouth of the material removal assembly 290 in the deployment direction and that are inversely oriented at about 30 degrees from one another when observed from the top plan view of FIG. 6A As such, the moldboards of the material clearing apparatus 290 also act as a funnel that directs the material that is caught within the moldboards towards the mouth of the material removal assembly 299 upon displacement of the material clearing apparatus 290 along the deployment direction of the articulated arm system 40. The material removal assembly 299 then ejects the material through a curved evacuation conduit, preferably away from the cleared surface, as better shown in FIG. 6C. In this embodiment, the material clearing apparatus 290 includes a material deflector 297 that arches over the funneling plow 293 to prevent funnelled material from drifting upwards, over, and behind the material clearing apparatus 290 while the articulated arm system 40 is under an extending motion. The material deflector 297 can alternatively be embodied by flaps. The material removal assembly 299 can be embodied in totality or in part by the “ice removal assembly” disclosed in PCT Application No. PCT/CA2023/050212 with the necessary adjustments that would be known to one of ordinary skills in the art.

In accordance with one embodiment, the moldboards of the V-shape plow 94 or funneling plow 293 are made at least partially with rubber of 80 Durometers. More specifically regarding the moldboard of the V-shape plow 94, an inferior portion of the moldboard that scrapes the surface to be cleared is made with Grade 5 rubber of 50 Durometers. According to one embodiment, the inferior portion of the moldboard of the V-shape plow 94 is 4 inches in height (or about 10 cm).

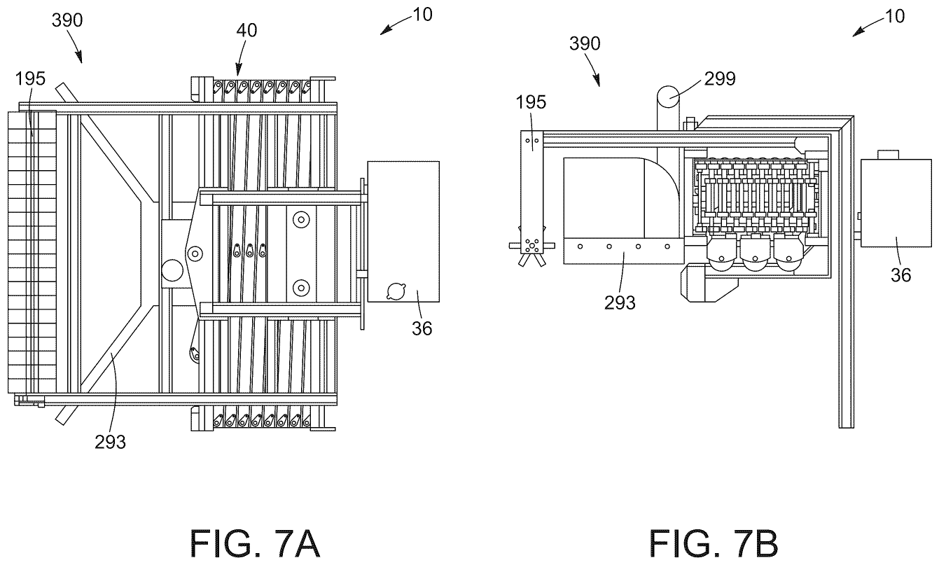

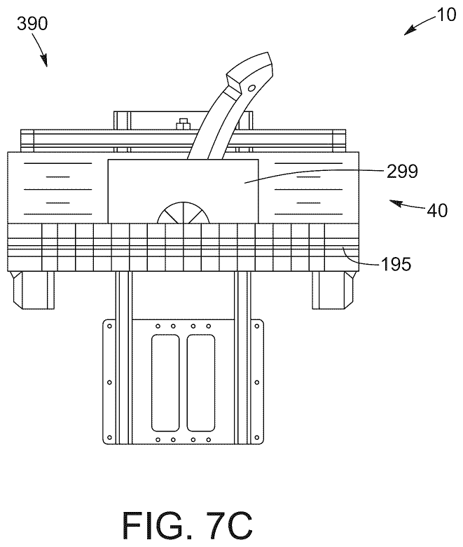

Turning to FIGS. 7A to 7C, there is shown yet another alternative embodiment of the material clearing apparatus 390 wherein the features are numbered with reference numerals in the 300 series which correspond to the reference numerals of the previous embodiments. The material clearing apparatus 390 shown in FIGS. 7A-7C is similar to the material clearing apparatus 290 shown in FIGS. 6A-6C, except that it also includes the rotating material remover 195 and the driver system described with respect to FIGS. 5A-5B. Similarly to the arrangement of FIGS. 5A-5B, the rotating material remover 195 is located on a distal side of the funneling plow 293. According to one mode of use, the rotating material remover 195 disturbs and/or shatters the material on the surface to be cleared. Then, the softened material is funneled by the funneling plow 293 into the mouth of the material removal assembly 299. In the embodiment shown, the material is then evacuated through a conduit, preferably away from the cleared surface. In other words, considered along the vehicle length, the funneling plow 293 is arranged between the rotating material remover 195 and the material removal assembly 299.

### Carrier

With reference to FIG. 8, there is shown an embodiment of a carrier 7 and a deployable system 10 not equipped with the material clearing assembly 90, 190, 290, 390 or the sets of scissor arms 50 of the articulated arm system 40. The embodiment shows the support structure 200, the proximal end portion 56 of the articulated arm system 40 (i.e., the overhanging arm base 58) and the bumper 70. The carrier 7 is specifically a “semi truck”, also known as a semi tractor, semi-trailer truck, 18-wheeler truck, etc. The semi-truck has a chassis 8 extending rearwardly and equipped with a structure-receiving member 9 represented by a vertically adjustable stand. In this embodiment, the deployable system 10 is adapted to mount to the adjustable stand 9. For instance, the adjustable stand 9 can be mounted on a pivotable base 11 configured to pivot about a substantially vertical axis X1. The deployable system 10 is therefore pivotable about the axis X1 upon actuation of the pivotable base 11.

A lower portion of the support structure 200 is leveled with the lower portion of the overhanging arm base 58 to form a semi-continuous surface that rests and is fixed on a top surface of the stand 9. Thus, the support structure 200 shown therein is exempt of the carrier-receiving plate 32. In the embodiment shown, the vertically adjustable stand 9 has a compacted height of 4 feet and 8 inches (or about 1.42 meters) in a compacted configuration and has an extended height of 12 feet in an extended configuration (or about 3.6 meters). The vertically adjustable stand 9 can be powered by a power assembly mounted to the chassis 8 of the carrier 7 or by the carrier itself.

According to an alternative embodiment, the deployable system 10 is fixed onto the stand 9 according to an orientation such that the deployment direction of the deployable system 10 is perpendicular to a longitudinal axis of the carrier 7.

The present disclosure also concerns an assembly that can be referred to as a deployable material clearing assembly 500 to clear the material for instance from the vehicle roof, as represented in FIG. 11. The assembly 500 comprises the deployable material clearing system 10 as described herein, and an archway structure 600, with the deployable material clearing system 10 being mounted to the archway structure 600 so as to hang from the archway structure at a height above ground level and allowing passage of a vehicle thereunder.

In the embodiment shown, the archway structure 600 comprises two vertical post 610, 620 (or vertical support assemblies 610, 620, or vertical post assemblies 610, 620) separated by a distance sufficient to move a vehicle therebetween. For instance, the first and second verticals post assemblies 610, 620 are separated by a distance sufficient to easily move a semi-trailer with a container trailer or an open-top tarped trailer, deliver truck, school bus, or highway coach bus therebetween. For instance, the first and second vertical post assemblies 610, 620 comprise a weighted base 612, 622 to contribute to the stability of the archway structure 600.

For example, the archway structure further comprises an upper cross piece 630 (or horizontal support member 630) forming an overhead bridge structure extending between the two vertical support assemblies 610, 620. In other words, the archway structure is substantially U-shaped. In the embodiment shown, the deployable material clearing system 10 extends between the first and second vertical post assemblies 610, 620, below and substantially parallel to the upper cross piece 630. For instance, the deployable material clearing system 10 is movable along the two vertical support assemblies 610, 620 in order to adjust a height of the ice-clearing apparatus above ground level, and thus a vertical position of the deployable material clearing system above the vehicle roof when in use. For the instance, the horizontal support member 630 is shaped and dimensioned to support a winch 640—or apparatus-lifting assembly 640—from which the deployable material clearing system 10 is supported by a chain 642 or cable connected. An operator at ground level can thus operate the apparatus-lifting assembly 640 to raise or lower the deployable material clearing system 10 to clear ice from vehicles of different heights. The first and second vertical support assemblies 610, 620 might also be shaped and dimensioned so as to guide a vertical displacement of the ice-clearing apparatus along the support assemblies 610, 620, upon actuation of the lifting carriage assembly 640. The lifting carriage assembly 640 might be operatively coupled to the above-mentioned controller so as to selectively move the deployable material clearing system 10 along longitudinal axes (i.e., vertical axes in the embodiment shown) defined by the first and second vertical support assemblies 610, 620. For instance, the controller might be operatively coupled to a pressure sensor arranged on the vehicle roof and/or the ice-clearing apparatus to adjust a vertical position of the ice-clearing apparatus via the actuation of the lifting carriage assembly as a function of a pressure applied by the ice-clearing apparatus onto the vehicle roof that would be measured by the pressure sensor.

It is appreciated that the shape and the configuration of the support structure, and the number, the components and the shape of the different components thereof can vary from the embodiment shown. deployable material clearing system

Method for Removing a Material from a Surface

According to a method for removing a material from a surface along a dimension thereof, the method comprises providing a deployable material clearing system 10 having a support structure 20, 200, a deployable articulated arm system 40, and a material clearing apparatus 90, 190, 290, 390, for instance as described in respect to one of the previous embodiments. First, the carrier-mounting support structure 20, 200 is mounted to a structure-receiving member 9 (for instance of a carrier 7 or of an archway structure 600). The structure-receiving member is at a desired installation-height from a ground such that at least a portion of the material clearing apparatus hovers over the surface. In some embodiments, such as the one illustrated in FIG. 8, the height of the structure-receiving member 9 is adjusted, if needed. Then, the carrier 7 is arranged, by being moved if needed, so that the deployment direction of the articulated arm system 40 is aligned with the dimension of the surface to be cleared. In some embodiments, subsequently or concurrently, a height of the structure-receiving member 9 can be adjusted to a desired installation-height relative to the ground such that at least a portion of the material clearing apparatus 90, 190, 290, 390 hovers over the surface to be cleared. Finally, the articulated arm system 40 is deployed along the dimension of the surface to operate the material clearing apparatus 90, 190, 290, 390.

In one implementation of the method in which the deployable system 10 includes a bumper 70, the method also includes abutting the bumper in a vicinity of the surface. For instance, if the surface to be cleared is a rooftop of a vehicle, the vicinity can be understood as a side or a periphery of the vehicle.

Depending on the embodiment of the material clearing apparatus, the installation-height of the structure-receiving member 9 is adjusted so that any of the V-shape plow (FIGS. 4A-5B), the funneling plow (FIGS. 6A-7C) and the rotating material remover (FIGS. 5A-5B and FIGS. 7A-7C) are operatively proximate with the surface to enable material removal when the articulated arm system 40 is deployed.

It is to be understood that the phraseology and terminology employed herein is not to be construed as limiting and are for descriptive purposes only. The principles and uses of the teachings of the present disclosure may be better understood with reference to the accompanying description, figures and examples. It is to be understood that the details set forth herein do not construe a limitation to an application of the disclosure.

In the description, an embodiment is an example or implementation. The various appearances of “one embodiment”, “an embodiment” or “some embodiments” do not necessarily all refer to the same embodiments. Although various features may be described in the context of a single embodiment, the features may also be provided separately or in any suitable combination. Conversely, although the invention may be described herein in the context of separate embodiments for clarity, it may also be implemented in a single embodiment. Reference in the specification to “some embodiments”, “an embodiment”, “one embodiment” or “other embodiments” means that a particular feature, structure, or characteristic described in connection with the embodiments is included in at least some embodiments, but not necessarily all embodiments.

Several alternative embodiments and examples have been described and illustrated herein. The embodiments of the invention described herein are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind.

Furthermore, it is to be understood that the disclosure can be carried out or practiced in various ways and that the disclosure can be implemented in embodiments other than the ones outlined in the description above. It is to be understood that the terms “including”, “comprising”, and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference should not be construed that there is only one of that element. It is to be understood that where the specification states that a component, feature, structure, or characteristic “may”, “might”, “can” or “could” be included, that particular component, feature, structure, or characteristic is not required to be included.

In the description, the same numerical references refer to similar elements. Furthermore, for the sake of simplicity and clarity, namely, so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional and are given for exemplification purposes only.

What is claimed is:

1. A deployable material clearing system for removing a material from a roof of a vehicle along a vehicle dimension thereof, the deployable material clearing system comprising:
a support structure;
a deployable arm system operatively couplable to a power unit and comprising:
a proximal end portion mounted to or formed integral with the support structure; and
a distal end portion;
wherein upon actuation of the power unit, the distal end portion is displaceable along the vehicle dimension to selectively extend the deployable arm system into an extended configuration or to configure the deployable arm system into a compacted configuration; and
a material clearing apparatus mounted to or formed integral with the distal end portion of the deployable arm system to hover at least a portion of the material clearing apparatus over the roof to remove the material along the vehicle dimension upon actuation of the power unit.

2. The deployable material clearing system of claim 1, wherein the deployable arm system is horizontally deployable.

3. The deployable material clearing system of claim 1, wherein the support structure comprises a mounting portion and a platform portion, wherein the proximal end portion of the deployable arm system is mounted to or formed integral with the platform portion.

4. The deployable material clearing system of claim 3, wherein the mounting portion of the support structure defines at least one carrier-mounting slot sized and shaped to receive a portion of a carrier.

5. The deployable material clearing system of claim 1, wherein the deployable arm system comprises at least one set of scissor arms, and wherein the proximal end portion and the distal end portion are located at opposite ends of the at least one set of scissor arms.

6. The deployable material clearing system of claim 5, wherein the at least one set of scissor arms includes first and second sets of scissor arms, wherein the second set of scissor arms is vertically superposed and interconnected to the first set of scissor arms.

7. The deployable material clearing system of claim 5, wherein the deployable arm system further comprises at least one arm actuator operatively couplable to the power unit and to the at least one set of scissor arms, to configure the deployable arm system into any one of the extended and compacted configurations.

8. The deployable material clearing system of claim 1, wherein the deployable material clearing system further comprises at least one bumper extending distally from one of the support structure and the proximal end portion of the deployable arm system, to abut on the vehicle.

9. The deployable material clearing system of claim 8, wherein the at least one bumper includes an elongated support member connected to one of the support structure and the proximal end portion of the deployable arm system, the elongated support member comprising a distal end at least partially formed of a resilient material.

10. The deployable material clearing system of claim 1, further comprising a wheel assembly mounted to or at least partially formed integral with a lower portion of the deployable arm system, the wheel assembly including at least one wheel axle and a plurality of wheels, each wheel being coupled to a corresponding wheel axle, the wheels being oriented in alignment with a deployment direction of the deployable arm system.

11. The deployable material clearing system of claim 10, wherein each of the at least one wheel axle is mounted to or formed integral with a respective axle pin assembly of the deployable arm system.

12. The deployable material clearing system of claim 1, wherein the material clearing apparatus is configured to remove the material from the roof of the vehicle upon extension of the deployable arm system.

13. The deployable material clearing system of claim 12, wherein the material clearing apparatus comprises a clearing body and a plow, the clearing body being coupled to the distal end portion of the deployable arm system and the plow extending downwardly with respect to the clearing body to scrape the roof and enable the removal of the material off the roof.

14. The deployable material clearing system of claim 13, wherein the plow has a V-shape oriented to evacuate the material over lateral edges of the roof as the deployable arm system is being extended into the extended configuration.

15. The deployable material clearing system of claim 1, wherein the material clearing apparatus comprises a driver system and a rotating material remover operatively couplable to the driver system, and wherein the driver system is operatively couplable to the power unit to selectively actuate the rotating material remover.

16. The deployable material clearing system of claim 15, wherein the plow is a funneling plow adapted to direct material to a mouth of the rotating material remover.

17. The deployable material clearing system of claim 1, wherein the material includes ice and/or snow.

18. A deployable system for hovering an apparatus over a roof of a vehicle along a vehicle dimension thereof, the deployable system comprising:
a support structure;
a deployable arm system operatively couplable to a power unit and comprising:
a proximal end portion mounted to or formed integral with the support structure; and
a distal end portion;
wherein upon actuation of the power unit, the distal end portion is displaceable along the vehicle dimension to selectively extend the deployable arm system into an extended configuration or to configure the deployable arm system into a compacted configuration; and
an apparatus-mounting frame mounted to or formed integral with the distal end portion of the deployable arm system, adapted to be coupled with the apparatus and to hover the apparatus over the roof upon actuation of the power unit.

19. A method for removing a material from a surface along a dimension thereof, the method comprising:
providing a deployable material clearing system having a support structure, a deployable arm system, and a material clearing apparatus;
mounting the support structure to a structure-receiving member, the structure-receiving member being at a desired installation-height from a ground such that at least a portion of the material clearing apparatus hovers over the surface;
aligning a deployment direction of the deployable arm system with the dimension of the surface; and
deploying the deployable arm system along the dimension of the surface to operate the material clearing apparatus.

20. The method of claim 19, wherein the deployable material clearing system further comprises a bumper, and wherein the method further comprises abutting the bumper in a vicinity of the surface.
